(19) United States
(12) Patent Application Publication
(10) Pub. No.: US 2002/0062170 A1
(43) Pub. Date: May 23, 2002

(54) Automated opto-electronic assembly machine and method

(76) Inventors: Timothy A. Skunes, Minneapolis, MN (US); Steven K. Case, St. Louis Park, MN (US); Gregory S. Mowry, Burnsville, MN (US)

Correspondence Address: WESTMAN, CHAMPLIN & KELLY, INTERNATIONAL CENTRE, SUITE 1600, 900 SECOND AVENUE SOUTH, MINNEAPOLIS, MN, 55402-3319, US

(21) Appl. No.: 09/894,872

(22) Filed: Jun. 27, 2001

Related U.S. Application Data
(60) Provisional application No. 60/214,846, filed on Jun. 28, 2000.

(51) Int. Cl. G06F 7/00; G06F 19/00; G06F 17/00

(52) U.S. Cl. 700/229; 700/230; 700/244; 700/112

(57) ABSTRACT

An automated assembly apparatus for assembling opto-electronic devices includes a pick and place machine adapted to receive at least one opto-electronic component and place the component in one of a plurality of a nano-precision assembly cells. The nano-precision assembly cells are adapted to receive components from the pick and place machine, and position or align the components with sub-micron accuracy.

The present application is based on and claims the benefit of U.S. provisional patent application Ser. No. 60/214,846, filed Jun. 28, 2000, the content of which is hereby incorporated by reference in its entirety.

### BACKGROUND OF THE INVENTION

The present invention relates to opto-electronic devices. More specifically, the present invention relates to assembly of opto-electronic devices.

Assembly of opto-electronic devices is an extremely labor-intensive process. Such assembly often includes manual alignment of opto-electronic components with sub-micron positional tolerances. Additionally, the process of delivering, inspecting and cleaning components is labor-intensive. Although some elements of automation do exist for opto-electronic device assembly, such as wire bonding, adhesive dispensation, and electrical component placement, systems for automatically assembling opto-electronic devices have not found wide acceptance.

In contrast, manufacture of printed circuit boards is typically effected using automated manufacturing lines. Printed circuit board assembly lines often incorporate machines connected by conveyor-tracks, each of which accomplishes specific functions. Once a given manufacturing step is completed, the conveyor transports the printed circuit board to the next manufacturing operation. For example, a printed circuit assembly line might include a screen-printing machine, a printer inspection machine, a pick and place (PNP) machine (for populating the printed circuit board with components), and finally component inspection, solder reflow, and printed circuit board testing machine. All of the above assembly line elements are well known in the art. Additionally, printed circuit board assembly is characterized by surface mount technology where assembly may be performed on substrates such as fiberglass or ceramic which are convenient elements for mounting electronic subassemblies such as integrated circuits, chip capacitors, etc. and electrically interconnecting them. Further, standard component delivery mechanisms such as tape and reel feeder systems, stick feeders, matrix tray and waffle pack delivery systems, and semiconductor wafer delivery systems are known and widely used in printed circuit board manufacture. Further still, common methods for aligning and attaching components to the printed circuit board, are used such that the components may be attached via epoxy or soldering. In summary, printed circuit board manufacture is an area that has progressed to such an extent that complex circuit boards are now manufactured relatively inexpensively.

Thus, there is a need for a system which automates the assembly of opto-electronic devices.

### SUMMARY OF THE INVENTION

An automated assembly apparatus for assembling opto-electronic devices is provided. The apparatus is a pick and place machine adapted to receive at least one opto-electronic component and place the component in a nano-precision assembly cell of a plurality of such cells. The nano-precision assembly cell is adapted to receive the component from the pick and place machine, and position the component with sub-micron accuracy.

### BRIEF DESCRIPTION OF THE DRAWINGS

FIG. 1 is a block diagram of an integrated automated manufacturing line in accordance with one example embodiment of the present invention.

FIG. 2 shows a nano-precision assembly cell for use in the automated manufacturing line of FIG. 1.

FIG. 3 is a block diagram of an automated opto-electronic manufacturing line in accordance with the invention which includes a database.

### DETAILED DESCRIPTION OF THE PREFERRED EMBODIMENTS

As discussed above, assembly of opto-electronic devices is substantially a manual process. One reason why automated assembly lines have not been widely employed is that the placement precision required for the opto-electronic device assembly is about 10 to 100 times greater than that required for current electronic device assembly. For example, known pick and place machines are generally able to place a component with a precision of about 1 to 2 microns. However, in order to successfully mount an opto-electronic device, placement precision may need to be as fine as 0.01 to 0.2 microns. Thus, manual assembly is generally implemented where operators manipulate sub-micron resolution stages to accurately place a given optical component. As can be appreciated, for a given opto-electronic device having a relatively large number of opto-electronic components, assembly time and thus labor costs is a significant expense. While the art of transmitting more and more data across fibers (e.g. dense wavelength division multiplexing) continues to advance at a rapid rate, the art of assembling opto-electronic devices that take advantage of such increased bandwidth, has been relatively stagnant.

Thus, there exists a need to provide a substantially fully automated opto-electronic device assembly line capable of assembling any number of opto-electronic and electronic components into a given device in an accurate, reliable, and cost effective manner. Other limitations of the prior art will become apparent upon review of the following materials.

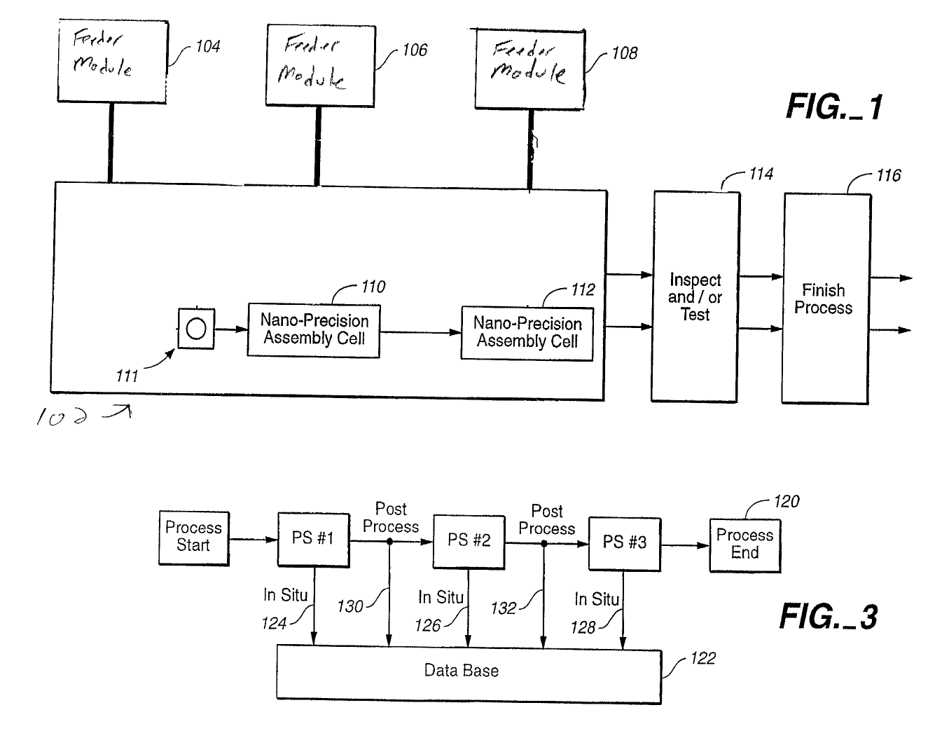

FIG. 1 is a diagrammatic view of a portion of an integrated automated manufacturing line for opto-electronic components in accordance with an embodiment of the present invention. A pick and place machine 102 is fed by component feeder modules 104, 106, and 108 through a delivery system. The feeder modules provide sub-devices which may or may not be pre-tested and/or pre-assembled. Those skilled in the art will appreciate that any number of feeder modules can be used. Moreover, each of feeders 104, 106, 108 represents the completion of a process step wherein opto-electronic components could be cleaned, for example by plasma cleaning, ultrasonic methods, or other suitable means; inspected using a video camera system coupled with machine vision analysis software to inspect the quality of the opto-electronic device; and/or placed into a carrier mechanism that is suitable for automated assembly processes. Examples of such carrier mechanisms include matrix trays, tapes and reels, stick feeders, magazines, cartridges, and other suitable devices. The inspections could include checking the focal length of a lens, the gain of an optical amplifier, the characteristics of an optical filter, or any other suitable parameter of a given opto-electronic device. The finished product of a given feeder block 104, 106, 108 is a number of opto-electronic devices arranged on a carrier mechanism suitable for assembly processes. The carrier mechanism is then coupled to pick and place machine 102 for assembly.

Pick and place machine 102 can be any suitable pick and place machine employing any combination of robotics and motion control to transport, manipulate, and place opto-electronic component, or electronic components, from feeders 104, 106, 108. An example of a simple pick and place machine is shown in FIG. 10 of U.S. Pat. No. 6,148,511 which issued Nov. 21, 2000. Further, since cleanliness of optical components is very important, pick and place machine 102 can include a source of filtered, laminar-flow air to reduce airborne particulates that could contaminate the optics. Additionally, pick and place machine 102 as well as nano-precision cells 110, 112, may be adapted to dispense epoxy, effect fusion splicing, clean components, laser welding, and/or solder components.

Pick and place machine 102 can include changeable grippers (e.g. vacuum quill) such that the grippers can be automatically changed based upon the component or subassembly to be transported. Pick and place machine 102 places opto-electronic components or subassemblies from feeders 104, 106, 108 into one of nano-precision assembly cells 110 or 112.

Feedback can be used in the machine 102, for example using a camera 111 or other techniques. As described above, the placement resolution of a known pick and place machine, such as pick and place machine 102 is coarse when compared with the placement precision required for opto-electronic device assembly. For example, known pick and place machines typically provide a placement accuracy of 1 to 2 microns at best. In this regard, the step of placing components from feeders 104, 106, and 108 into nano-precision assembly cells 110 and 112 can be considered a coarse placement, or first-stage placement. Once the opto-electronic components or subassemblies are placed into nano-precision assembly cells, such cells automatically effect fine alignment and assembly. As used herein, “fine” alignment and assembly refers to sub-micron movements. Such alignment and assembly can include component positioning, alignment, and mounting (either permanent, or interim, such as tacking). As will be described in greater detail, opto-electronic components and subassemblies that are tacked during nano-precision assembly are generally post-processed to cure, or otherwise complete, the mounting bond.

Once the opto-electronic components or subassemblies are aligned using nano-precision assembly cells 110 and 112, the opto-electronic assembly is transferred to a inspect and/or test station 114 where post processing is completed. Examples of post processing include inspections of the opto-electronic assembly to determine if first stage (coarse) and second stage (fine) assembly operations were completed successfully. Such inspection may include video inspection of the assembled device, functional inspections of the assembled device, any combination of the two, or other suitable inspections. As can be appreciated, each individual opto-electronic component or subassembly may lend itself to specific types of inspections. For example, if a semi-conductor laser is placed using nano-precision assembly cell 110, post processing block 114 may inspect the placement and alignment of the device itself while functional inspections may determine whether the device provides sufficient optical energy in one or more desired wavelengths. Preferably, information ascertained at both the nano-precision assembly cell 110, 112 and post-processing block 114 is stored in a coherent database (shown in FIG. 3) such that information is accumulated relative to each process step as opto-electronic devices are manufactured using embodiments of the present invention.

The above-described machine and method allow the speed of commercially available pick and place machines to be efficiently combined with automatic sub-micron assembly stages. Depending on the cost, commercially available pick and place machines are generally able to rapidly place (at a rate of generally 10 components per second) generic components to within approximately ±1.5 micrometers to approximately ±20 micrometers, of their intended absolute location. Although this placement accuracy is acceptable for electrical components on printed circuit boards, this range is roughly 10 to 100 times larger than that required for opto-electronic component alignment.

While methods do exist for precisely locating components to tolerances on the order of tens of nanometers (0.1 micrometers to 0.01 micrometers), such methods suffer from relatively long alignment times (tens of seconds to minutes) because they typically initiate the alignment operation with the assemblies separated by many microns. Since one micron equals 1,000 nanometers, such alignments are relatively time consuming. Further, such alignments provide no mechanism for rapidly bringing components closer together in order to minimize the final alignment search space. Hence, the alignment time is extensive because alignment algorithms must search over a large volume of three dimensional space with very small step increments. This drawback is further enhanced due to the lack of standardized building blocks and assembly tools. By leveraging pick and place alignment speeds, with automated nano-precision assembly cells, much more precise automated assembly can be performed in a timely manner thereby enabling the automatic mass production of opto-electronic devices.

As can be appreciated, incorporating one to several nano-precision assembly cells within a single pick and place machine resolves the mutually inconsistent requirements of machines having rapid placement with poor spatial accuracy versus machines with precise accuracy but slow alignment due to large search space volumes. A pick and place machine can rapidly place several optical components into several nano-precision assembly cells such that component alignment is relatively close to its desired final value. This minimizes the three dimensional volume search space that the nano-precision assembly cell algorithms are required to search over and converge thus rapidly decreasing alignment times. A plurality of nano-precision assembly cells then align groups of opto-electronic components or subassemblies simultaneously during each incremental placement cycle. The plurality of nano-precision assembly cells can thus match the pick and place component delivery rate to the somewhat slower capability of each individual nano-precision assembly cell. Multiple pick and place machine grippers may be used to separate the load and unload operations. Another attribute of the combined pick and place machine using nano-precision assembly cells is that preassembled subassemblies can be powered up and actively aligned during the nano-precision assembly process by the pick and place machine or the nano-precision assembly cell. Therefore, once pick and place machine 102 places the opto-electronic component or subassembly into nano-precision assembly cell 110, 112, nano-precision assembly cell 110, 112 (which can be tooled to permit active or passive alignments) completes the alignment process in a manner consistent with the operating principles of opto-electronic components.

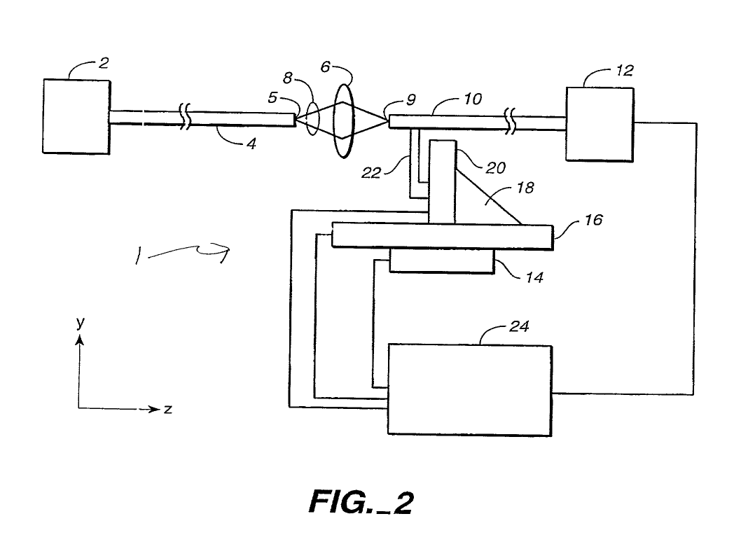

FIG. 2 is a diagrammatic view of opto-electronic component 10 (in this case an optical fiber) being aligned within a nano-precision assembly cell 1 which can be, for example, cell 110 or 112 shown in FIG. 1. The alignment of component 10 is illustrated using active alignment. For example, light source 2 transmits light into optical fiber 4 which diverges from end 5 as indicated by light beam 8. Beam 8 passes through lens 6 and begins to converge upon end 9 of optical component 10. Detector 12 provides feedback to a controller 24, which controls the translation of opto-electronic component 10 relative to lens 6. In this example, detector 12 is a photo detector that provides a signal indicative of total light power within optical fiber 10, wherein optimal component alignment is the position of maximum total light power.

FIG. 2 illustrates X-direction linear translation stage 14 disposed upon Z-direction linear translation stage 16. Y-direction linear translation stage 20 is disposed upon linear translation stage 16 and is supported thereon by support bracket 18. Each of the linear translation stages 14, 16, 20 includes suitable motion control drives, and sensing electronics and are coupled to a controller 24 in accordance known motion control techniques. Gripping device 22 is coupled to linear translation stage 20 and is adapted to grip opto-electronic component 10 such that opto-electronic component 10 can be manipulated in three mutually perpendicular axes. Those skilled in the art will recognize that more or less nano-precision stages could be used to provide more or less degrees of freedom to the manipulation of opto-electronic component 10. For example, the positioner shown in FIG. 2 can be a rotary positioner and can be provided alone or in addition to linear translation.

Although the alignment of component 10 is described as active alignment in reference to optical power, other alignment feedback mechanisms can be used with various embodiments of the present invention. Examples of such additional feedback mechanisms include optical wavelength, spectrum, video image, dispersion, gain, polarization, coupling efficiency, wavefront quality, autocollimation (angle detection), beam position, and any other suitable mechanisms.

Another example of in situ processing data and inspection occurs during the placement of a laser stripe, when such stripe is being aligned to and focused upon a linear CCD array. Both the laser and the linear CCD array need to be oriented relative to each other. This requires that x, y, x, theta, and phi (2 angles) be monitored for both devices. In addition, the output of the linear array needs to be monitored (i.e. the electrical signal resulting from light falling on the linear CCD array) to ensure that the laser stripe is in focus on the array and that all of the array pixels are symmetrically illuminated with respect to the array center.

Each nano-precision assembly cell incorporates one or more of translation devices capable of very fine (sub-micron) motion. Such translation devices may be linear, rotary, or adapted for a more complex motion profile. Some linear translations provided by such devices may be on the order of a few nanometers. As shown in FIG. 2, light source 2 which couples light into fiber 4 could be part of the nano-precision assembly cell used for placing opto-electronic component 10. Additionally, source 2 could also be a pre-assembled subassembly that is powered by the nano-precision assembly cell. Source 2 could also be a partially assembled opto-electronic device from another previous nano-precision assembly cell in pick and place machine 102. For example, source 2 could be provided to nano-precision assembly cell 112 from nano-precision assembly cell 110.

Referring back to FIG. 1, upon completion of the nano-precision assembly cell operations, the opto-electronic devices or subassemblies are transferred to inspect and/or test station 114. During this stage of the manufacturing process, the previous operation can be verified and additional testing can be performed as needed. With regard to inspection, many inspection methods are possible, including machine vision analysis. Once the operations of inspect and/or test station 114 are completed, the opto-electronic device or subassembly is transferred to finish process block 116.

At block 116, any remaining operations that are required to be completed in this particular processing operation are finished. For example, the opto-electronic subassemblies may require marking, soldering, wire-bonding, curing (e.g. ultraviolet, and/or thermal curing), burn-in and so forth. Of course, stations 114 and 116 may actually be physically located within pick and place machine 102. Finish process 116 is executed only on devices which have passed the previous inspection and test steps. Thus, the processing flow described with respect to FIG. 1 assures that failed devices (e.g. dead-on-arrival assemblies) are rejected before the entire process is completed. In a high-volume automated manufacturing line, this intermediate ability to test and reject failed subassemblies can result in considerable savings in manufacturing costs. Once finish process block 116 has completed, the opto-electronic device or subassembly is ready to move onto the next logical step. The next logical step may be anything ranging from delivery to another pick and place machine which adds further optical components or subassemblies similar to the process described with respect to FIG. 1, or delivered to a carrier transport to be provided as tested/preassembled subassemblies for feeder blocks in an opto-electronic automated manufacturing line. Thus, aspects of the present invention are readily scalable from placing a single opto-electronic device to assembling an entire opto-electronic device having hundreds of opto-electronic components and subassemblies.

FIG. 3 is a diagrammatic view of an automated opto-electronic manufacturing line that is adapted to acquire data relative to opto-electronic components and subassemblies during opto-electronic device manufacture. FIG. 3 shows three processing steps labeled PS1, PS2, and PS3, however, any number of processing steps can be provided. Each processing step of FIG. 3 can encompass a portion of or the entire processing method described with respect to FIG. 1. For example, PS1 may include all of the steps described with respect to FIG. 1. Thus, as describe above, when finish process block 116 provides the opto-electronic components or subassemblies to the next logical step, FIG. 3 shows an example where the next logical step is a similar assembly routine which in turn provides its finished product to yet another assembly routine which finally finishes the process at block 120.

As can be seen, each of process steps PS1, PS2, and PS3 provide in situ opto-electronic assembly information to coherent database 122 via lines 124, 126, and 128, respectively. The in situ data provided by each processing step is that data that is obtained during inspect and/or test block 114 for each processing step. As described above, such inspections vary widely depending on the type of opto-electronic component or subassembly used. Preferably, additional process information is also obtained between process steps as indicated by lines 130 and 132. Thus, during various stages of opto-electronic device manufacture, a wealth of process assembly information is accumulated.

As multiple opto-electronic devices are assembled through the described process, the database can facilitate analysis of individual process steps or nano-precision assembly steps such that trends may be realized, and/or the assembly otherwise optimized. The data in coherent database 122 can be provided to the process engineering staff as well as design engineering staff such that the process and/or design can be optimized. Further, data from coherent database 122 can also be provided to controller 24 (typically one or more personal computers) such that real time process optimization is achieved. Thus, the data stored in coherent database 122 is useful for controlling processes, developing statistically sound empirical trend models, establishing the validity of device models, analyzing field failures, and many other potential uses. Preferably, data is tagged and stored in coherent database 122 in a manner that facilitates later (or potentially real-time) retrieval and correlation back to the fundamental components (whether individual opto-electronic components, or subassemblies) used in the assembly. This is why database 122 is labeled a coherent database. As subassemblies are built up throughout the manufacturing process, the coherent data set correspondingly grows. It is preferable that data within the coherent database be tagged and linked to correspondingly more complex assembly and to the final completed assembly to permit detailed analysis of the assembly.

Embodiments of the present invention are useful for high speed, automated assembly of opto-electronic devices. Examples of such opto-electronic devices include fiberoptic telecommunication devices, optical sensors for distance measurement, and CD ROM drives for data storage applications. Additionally, opto-electronic components include fibers, connectors, lenses (gradient index, conventional, diffractive, ball, etc.), mirrors, filters (including interference filters), gratings, integrated optical components (switches, AWG's, couplers, etc.), light sources (laser, LED, incandescent, strobe, etc), detectors (PIN, APD, bi-cell, linear CCD array, area CCD array, etc.), fiber Bragg gratings, semiconductor optical amplifiers, fiber amplifiers (for example Erbium Doped Fiber Amplifier (EDFA)), optical isolators, MEMS-based multiplexers and demultiplexers, and other opto-electronic components.

The present invention can use, and can be used with, devices and techniques shown and/or described in application Ser. No. 09/789,125, filed Feb. 20, 2001, entitled OPTICAL MODULE; application Ser. No. 09/789,185, filed Feb. 20, 2001, entitled OPTICAL MODULE WITH SOLDER BOND; application Ser. No. 09/789,124, filed Feb. 20, 2001, entitled OPTICAL DEVICE; application Ser. No. 09/789,317, filed Feb. 20, 2001, entitled OPTICAL ALIGNMENT SYSTEM; application Ser. No. 60/276,323, filed Mar. 16, 2001, entitled OPTICAL CIRCUIT PICK AND PLACE MACHINE; application Ser. No. 60/276,335, filed Mar. 16, 2001, entitled OPTICAL CIRCUITS WITH ELECTRICAL SIGNAL ROUTING; application Ser. No. 60/276,336, filed Mar. 16, 2001, entitled OPTICAL CIRCUITS WITH THERMAL MANAGEMENT; and application Ser. No. 60/288,169, filed May 2, 2001, entitled OPTICAL CIRCUIT PICK AND PLACE MACHINE, which are incorporated herein by reference in their entirety.

Although the present invention has been described with reference to preferred embodiments, workers skilled in the art will recognize that changes may be made in form and detail without departing from the spirit and scope of the invention. When multiple nano-precision cells are used, the placements can occur at any time including all or some occurring substantially simultaneously, when placing multiple components, the components can be of the same or of different types.

What is claimed is:

1. An automated assembly apparatus for assembling opto-electronic devices, the apparatus comprising;
a pick and place machine adapted to receive opto-electronic components and place the components in nano-precision assembly cells;
a plurality of nano-precision assembly cells adapted to receive the components from the pick and place machine, and align the components with sub-micron accuracy.

2. The apparatus of claim 1 wherein the components are of differing types.

3. The apparatus of claim 1 wherein the nano-precision placements are performed substantially simultaneously.

4. The apparatus of claim 1 including a feeder comprising a carrier transport, and the carrier transport is adapted to releasably hold multiple opto-electronic components.

5. The apparatus of claim 1, including a feeder comprising a carrier transport, and the carrier transport is adapted to releasably hold multiple opto-electronic subassemblies.

6. The apparatus of claim 1, including a tape and reel feeder system to provide the opto-electronic components.

7. The apparatus of claim 1, including a matrix tray delivery system to provide the opt-electronic components.

8. The apparatus of claim 1, including a semiconductor wafer delivery system to provide the opto-electronic components.

9. The apparatus of claim 1, and further comprising:
memory adapted to store a coherent data base; and
inspection equipment adapted to provide data to the coherent database indicative of at least one parameter related to efficacy of component placement.

10. The apparatus of claim 1 including a database configured to contain data related to alignment of the opto-electronic component.

11. The apparatus of claim 10 wherein the data is further related to in-situ assembly information.

12. The apparatus of claim 11 wherein the in-situ assembly information is obtained through active inspection of the opto-electronic component.

13. The apparatus of claim 11 wherein the in-situ assembly information is obtained through passive inspection of the opto-electronic component.

14. The apparatus of claim 1 wherein the nano-precision assembly cell uses an active alignment technique to position the opto-electronic component.

15. The apparatus of claim 1 wherein the nano-precision assembly cell uses a passive alignment technique to position the opto-electronic component.

16. The apparatus of claim 1 including an inspection and test stage.

17. The apparatus of claim 1 wherein the pick and place machine is configured to provide an electrical connection to the at least one opto-electronic component.

18. The apparatus of claim 1 wherein the nano-precision assembly cell includes at least one linear actuator to position the opto-electronic component.

19. The apparatus of claim 1 wherein the nano-precision assembly cell includes at least one rotary actuator to position the opto-electronic component.

20. The apparatus of claim 1 wherein the nano-precision assembly cell is configured to dispense epoxy.

21. The apparatus of claim 1 wherein the nano-precision assembly cell is configured to clean components.

22. The apparatus of claim 1 wherein the nano-precision assembly cell is configured to effect fusion splicing.

23. The apparatus of claim 1 wherein the nano-precision assembly cell is configured to weld components.

24. The apparatus of claim 1 wherein the nano-precision assembly cell is configured to solder components.

25. The apparatus of claim 1 wherein the pick and place machine includes a changeable gripper.

26. The apparatus of claim 1 wherein the pick and place machine includes a vacuum quill.

27. The apparatus of claim 1 wherein placement accuracy of the pick and place machine is less than placement accuracy of nano-precision assembly cell.

28. A method of building an optical device, comprising:
(a) picking up a first optical component from a feeder location and placing the first optical component into a first precision placement cell;
(b) receiving the first optical component within the first precision placement cell and performing precision placement of the first optical component;
(d) picking up a second optical component from a feeder location and placing the second optical component into a second precision placement cell; and
(e) receiving the second optical component within the second precision placement cell and performing precision placement of the second optical component.

29. The method of claim 28 wherein steps (b) and (d) are performed substantially simultaneously.

30. The method of claim 28 wherein steps (b) and (d) are performed substantially sequentially.

31. The method of claim 28 wherein the optical components are picked up from a feeder.

32. The method of claim 28 including inspecting the optical components.

33. The method of claim 32 including creating a coherent database based upon the inspection of the components.

34. The method of claim 33 wherein the database contains information related to alignment of the components.

35. The method of claim 34 wherein the data is related to in-situ assembly information.

36. The method of claim 32 wherein the inspecting comprises an active inspection.

37. The method of claim 32 wherein the inspecting comprises a passive inspection.

38. The method of claim 28 wherein performing precision placement includes actively aligning the components.

39. The method of claim 28 wherein performing precision placement includes passively aligning the components.

40. The method of claim 28 providing an electrical connection to the component.

41. The method of claim 28 including dispensing an adhesive to secure the component.

42. The method of claim 28 including cleaning the component prior to the placement.

43. The method of claim 28 including selecting a gripper for use in the step of picking up.

44. The method of claim 28 wherein the step of placing the components into the placement cells is less accurate the step of performing a precision placement.

45. The method of claim 28 including inspecting the optical device following performing precision placement of an optical component.

46. An apparatus configured to perform the method of claim 28.

47. Computer software configured to implement the method of claim 28.

48. An optical device manufactured in accordance with the method of claim 28.

49. The method of claim 28 including placing the aligned first optical component into the second precision placement cell prior following step (b).
